(19) United States
(12) Patent Application Publication
(10) Pub. No.: US 2023/0398521 A1
(43) Pub. Date: Dec. 14, 2023

(54) WATER-GAS SHIFT REACTION CATALYSTS

(71) Applicant: CLARIANT INTERNATIONAL LTD, Muttenz (CH)

(72) Inventors: Hongyi Hou, Sunnyvale, CA (US); Claus G. Lugmair, Santa Cruz, CA (US); Tobias Henkel, Takaramachi (JP); Robert J. O’Brien, Louisville, KY (US); Marian Alcid, Sunnyvale, CA (US); Yangxue Gao, Mountain View, CA (US); Tony Volpe, Santa Clara, CA (US)

(21) Appl. No.: 18/200,036

(22) Filed: May 22, 2023

Related U.S. Application Data
(60) Provisional application No. 63/350,739, filed on Jun. 9, 2022.

(51) Int. Cl. B01J 23/80; B01J 21/02; B01J 23/72; B01J 23/847; B01J 21/10; B01J 23/75; B01J 23/745; B01J 23/00; B01J 37/08; B01J 37/03; C01B 3/16

(52) U.S. Cl. CPC B01J 23/80; B01J 21/02; B01J 23/72; B01J 23/8472; B01J 21/10; B01J 23/75; B01J 23/745; B01J 23/005; B01J 37/08; B01J 37/031; C01B 3/16; C01B 2203/0283; C01B 2203/1052; C01B 2203/1076

(57) ABSTRACT

This invention describes water-gas shift reaction catalyst materials. More particularly, the present invention describes spinel-comprising catalysts useful in high-temperature water-gas shift reactions, to methods for making such catalysts, and to methods for forming hydrogen with such catalysts.

### CROSS-REFERENCE TO RELATED APPLICATIONS

This application claims priority to U.S. Provisional Patent Application Ser. No. 63/350,739 filed Jun. 9, 2022, which is incorporated herein by reference in its entirety.

### BACKGROUND OF THE DISCLOSURE

### Field of the Disclosure

This disclosure relates generally to water-gas shift reaction catalyst materials. More particularly, the present disclosure relates to spinel-comprising catalysts useful in high-temperature water-gas shift reactions, to methods for making such catalysts, and to methods for forming hydrogen with such catalysts.

### Technical Background

The water-gas shift reaction is a well-known reaction through which hydrogen is formed from water vapor and carbon monoxide. Large volumes of hydrogen gas are needed for a number of important chemical reactions. Since the 1940s, the water-gas shift reaction has represented an important step in the industrial production of hydrogen. For example, an industrial-scale water-gas shift reaction is used to increase the production of hydrogen for refinery hydro-processes and for use in the production of bulk chemicals such as ammonia, methanol, and alternative hydrocarbon fuels.

Conventionally, the catalysts used in industrial-scale water-gas shift reactions include either an iron-chromium metal combination or a copper-zinc metal combination. The iron-chromium oxide catalyst is typically used in high-temperature shift (HTS) converters, which typically have reactor inlet temperatures of about 300° C. to about 380° C. Conventional HTS converters use iron-based catalysts. Typically, conventional catalysts are supplied in the form of pellets containing 8%-12% Cr₂O₃ and a small amount of copper as an activity and selectivity enhancer.

However, chromium can be toxic and carcinogenic, and therefore highly undesirable for use on an industrial scale due to health and environmental concerns. Moreover, iron-containing HTS catalysts are only operable under a limited range of steam-to-gas ratios (S/G; i.e., the molar ratio of H₂O to the total of H₂, N₂, CO₂, and CO), because at low S/G, the catalyst is reduced to iron carbides, which produce hydrocarbon byproducts.

Accordingly, there remains a need for water-gas shift reaction catalysts that can be prepared without chromium and optionally without iron, without significantly affecting performance. There further remains a need for water-gas shift reaction catalysts that can be operated at a wider S/G range than that afforded by conventional catalysts.

### SUMMARY OF THE DISCLOSURE

One aspect of the disclosure is a water-gas shift reaction catalyst composition comprising:
zinc, present in the composition in an amount within the range of 20 wt. % to 70 wt. %;
aluminum, present in the composition in an amount within the range of 5 wt. % to 40 wt. %;
one or more promoters selected from vanadium, magnesium, copper, cobalt, iron, cerium, manganese, calcium, nickel, boron, zirconium, potassium, and silicon, the one or more promoters being present in the composition in a total amount within the range of 0.1 wt. % to 25 wt. %; and
oxygen, present in the composition in an amount within the range of 15 wt. % to 50 wt. %.
   Such materials can be made having a high degree of material in a crystalline spinel form, as described in detail herein.

Another aspect of the disclosure is a method for preparing a water-gas shift reaction catalyst composition (e.g., according to an embodiment as described herein), the method comprising
providing a spinel precursor comprising zinc; aluminum; one or more promoters selected from vanadium, magnesium, copper, cobalt, iron, cerium, manganese, calcium, nickel, boron, zirconium, potassium, and silicon; and oxygen; and
calcining the spinel precursor,
   wherein the catalyst composition comprises
zinc, present in the composition in an amount within the range of 20 wt. % to 70 wt. %;
aluminum, present in the composition in an amount within the range of 5 wt. % to 40 wt. %;
one or more promoters selected from vanadium, magnesium, copper, cobalt, iron, cerium, manganese, calcium, nickel, boron, zirconium, potassium, and silicon, each promoter present in the composition in an amount within the range of 0.1 wt. % to 25 wt. %; and
oxygen, present in the composition in an amount within the range of 15 wt. % to 50 wt. % (e.g., as further described in any embodiment herein).

Another embodiment of the disclosure is a method for performing a water-gas shift reaction, the method comprising contacting a feed comprising water and carbon monoxide with a catalyst composition as described herein to form hydrogen and carbon dioxide.

### BRIEF DESCRIPTION OF THE DRAWINGS

FIG. 1 is a plot of the X-ray diffraction (XRD) patterns of certain materials described herein.

FIG. 2 is a plot of the XRD patterns of certain materials described herein.

### DETAILED DESCRIPTION

The disclosure relates to calcined water-gas shift reaction catalyst compositions that include zinc, aluminum, oxygen, and one or more promoters selected from vanadium, magnesium, copper, cobalt, iron, cerium, manganese, calcium, nickel, boron, zirconium, potassium, and silicon. In various advantageous aspects and embodiments of the compositions as otherwise described herein, the zinc, aluminum, oxygen, and/or the one or more promoters together form a spinel crystalline structure. The disclosure demonstrates that such catalysts, which can advantageously be substantially free of chromium, can exhibit activity comparable to or higher than the conventional iron/chromium catalysts. The disclosure demonstrates that such catalysts can, in certain embodiments, be free of iron-containing materials, and accordingly operate under a wider range of steam-to-gas (S/G) ratios relative to catalysts prepared according to conventional methods.

Accordingly, one aspect of the disclosure is a water-gas shift reaction catalyst composition. The catalyst composition includes zinc, present in the composition in an amount within the range of 20 wt. % to 70 wt. %; aluminum, present in the composition in an amount within the range of 5 wt. % to 40 wt. %; oxygen, present in the composition in an amount within the range of 15 wt. % to 50 wt. %; and one or more promoters selected from vanadium, magnesium, copper, cobalt, iron, cerium, manganese, calcium, nickel, boron, zirconium, potassium, and silicon, the one or more promoters being present in the composition in a total amount within the range of 0.1 wt. % to 25 wt. %, e.g., in the range of 0.1 wt % to 20 wt %.

The present inventors have determined that spinel-based structures can advantageously provide good catalytic activity, even in the absence of chromium (and, in some embodiments, even in the absence of iron). In certain embodiments of the compositions as otherwise described herein, at least a portion of the aluminum, zinc, and/or one or more promoters of the composition form a spinel structure with at least a portion of the oxygen of the composition. In certain such embodiments, aluminum, zinc, and/or one or more promoters occupy tetrahedral and/or octahedral sites of a face-centered cubic array of oxygen. The person of ordinary skill in the art will appreciate that, while in a normal spinel structure, trivalent ions occupy octahedral sites and divalent ions occupy tetrahedral sites, spinel structures generally may comprise trivalent ions occupying octahedral and/or tetrahedral sites, and divalent ions occupying octahedral and/or tetrahedral sites. For example, the person of ordinary skill in the art will appreciate that, in an inverse spinel structure, divalent ions occupy octahedral sites and trivalent ions occupy both octahedral and tetrahedral sites.

In certain embodiments as otherwise described herein, at least a portion of the zinc of the composition forms an oxide with at least a portion of the oxygen of the composition. For example, in certain embodiments as otherwise described herein, at least 80 wt. % (e.g., at least 85 wt. %, or at least 90 wt. %) of the catalyst composition comprises zinc oxide and a crystalline spinel material having a structure in which one or more promoters, aluminum, and/or zinc occupy tetrahedral and/or octahedral sites of a face-centered cubic array of oxygen. For example, in some embodiments, at least 95 wt. % (e.g., at least 97.5 wt. %, or at least 99 wt. %) of the catalyst composition comprises zinc oxide and the crystalline spinel material. In certain such embodiments, at least 50 wt. % (e.g., at least 60 wt. %, or at least 70 wt. %) of the catalyst composition is the crystalline spinel material.

Notably, the promoters can become part of the spinel structure. Advantageously, the present inventors have determined that incorporation of at least a portion of the promoters into the spinel structure can provide improved catalyst activity. Without being bound by theory, the improvement could be attributed to the defects and distortion introduced into the spinel structure upon incorporation of one or more promoters, as indicated by evidence of unit cell expansion, as well as a lack of additional phases from the promoter. Accordingly, in certain embodiments, the materials of the disclosure do not include a promoter-containing phase (e.g., selected from vanadium, magnesium, copper, cobalt, iron, cerium, manganese, calcium, nickel, boron, zirconium, potassium, and silicon, as described below) in an amount in excess of 5% (e.g., in excess of 2% or in excess of 0.1%) of the material. For example, in certain embodiments of the compositions as otherwise described herein, the material is substantially free of promoter-containing phases separate from the spinel structure.

In certain embodiments as otherwise described herein, the crystalline spinel unit cell includes a dimension (e.g., “a” of a ZnAl₂O₄-type or a ZnFe_{1.5}Al_{0.5}O₄-type spinel) of at least 8.1 Å. For example, in certain such embodiments, the crystalline spinel unit cell includes a dimension of at least 8.125 Å, or at least 8.15 Å, or at least 8.175 Å, or at least 8.2 Å, or at least 8.225 Å, or at least 8.25 Å. As the person of ordinary skill in the art will appreciate, crystalline dimensions can be determined using x-ray crystallography.

As noted above, zinc is present in the composition in an amount within the range of 20 wt. % to 70 wt. %. The amount of zinc in the catalyst compositions of the disclosure can vary within this range. For example, in certain embodiments as otherwise described herein, zinc is present in the composition in an amount within the range of 25 wt. % to 70 wt. %, for example, in the range of 30 wt. % to 70 wt. %, or 35 wt. % to 70 wt. %, or 40 wt. % to 70 wt. %, or 50 wt. % to 70 wt. %. In certain embodiments as otherwise described herein, zinc is present in the composition within the range of 20 wt % to 65 wt %, e.g., in the range of 25 wt. % to 65 wt. %, or 30 wt. % to 65 wt. %, or 35 wt. % to 65 wt. %, or 40 wt. % to 65 wt. %, or 50 wt % to 65 wt %. In certain embodiments as otherwise described herein, zinc is present in the composition within the range of 20 wt % to 60 wt %, e.g., in the range of 25 wt. % to 60 wt. %, or 30 wt. % to 60 wt. %, or 35 wt. % to 60 wt. %, or 40 wt. % to 60 wt. %, or 45 wt % to 60 wt %. In certain embodiments as otherwise described herein, zinc is present in the composition within the range of 20 wt % to 55 wt %, e.g., in the range of 25 wt. % to 55 wt. %, or 30 wt. % to 55 wt. %, or 35 wt. % to 55 wt. %, or 40 wt. % to 55 wt. %. In certain embodiments as otherwise described herein, zinc is present in the composition within the range of 20 wt % to 50 wt %, e.g., in the range of 25 wt. % to 50 wt. %, or 30 wt. % to 50 wt. %, or 35 wt. % to 50 wt. %. Zinc is calculated as elemental zinc on an as-calcined basis. It is contemplated that an amount of zinc in this paragraph can be combined with any amount of aluminum, any amount of oxygen, and any amount(s) of promoter(s) as described elsewhere herein.

As noted above, aluminum is present in the composition in an amount within the range of 5 wt. % to 40 wt. %. As with zinc, the amount of aluminum in the compositions of the disclosure can vary. In certain embodiments as otherwise described herein, aluminum is present in the composition in an amount within the range of 10 wt. % to 40 wt. %, e.g., 15 wt. % to 40 wt. %, or 20 wt. % to 40 wt. %, or 25 wt. % to 40 wt. %, or 30 wt % to 40 wt %. In certain embodiments as otherwise described herein, aluminum is present in the composition in an amount within the range of 5 wt. % to 35 wt. %, e.g., 10 wt % to 35 wt %, or 15 wt. % to 35 wt. %, or 20 wt. % to 35 wt. %, or 25 wt. % to 35 wt. %. In certain embodiments as otherwise described herein, aluminum is present in the composition in an amount within the range of 5 wt. % to 30 wt. %, e.g., 10 wt % to 30 wt %, or 15 wt. % to 30 wt. %, or 20 wt. % to 30 wt. %. In certain embodiments as otherwise described herein, aluminum is present in the composition in an amount within the range of 5 wt. % to 25 wt. %, e.g., 10 wt % to 25 wt %, or 15 wt. % to 25 wt. %. In certain embodiments as otherwise described herein, aluminum is present in the composition in an amount within the range of 5 wt. % to 20 wt. %, e.g., 10 wt % to 20 wt % or 5 wt % to 15 wt %. Aluminum is calculated as elemental aluminum on a calcined basis. It is contemplated that an amount of aluminum in this paragraph can be combined with any amount of zinc, oxygen, any amount of and any amount(s) of promoter(s) as described elsewhere herein.

As noted above, oxygen is present in the composition in an amount within the range of 15 wt. % to 50 wt. %. The amount of oxygen in the compositions described herein can also vary. Oxygen is desirably present in the compositions in an amount sufficient to balance the charges, although in some embodiments there can be small amounts (desirably less than 1 wt. %) of other formally anionic materials (e.g., halide) to balance charge. In certain embodiments as otherwise described herein, oxygen is present in an amount within the range of 20 wt. % to 50 wt. %, e.g., 25 wt. % to 50 wt. %, or 30 wt. % to 50 wt. %, or 35 wt. % to 50 wt. %, or 40 wt. % to 50 wt %. In certain embodiments as otherwise described herein, oxygen is present in an amount within the range of 20 wt. % to 45 wt. %, e.g., 25 wt. % to 45 wt. %, or 30 wt. % to 45 wt. %, or 35 wt. % to 45 wt. %. In certain embodiments as otherwise described herein, oxygen is present in an amount within the range of 20 wt. % to 40 wt. %, e.g., 25 wt. % to 40 wt. %, or 30 wt. % to 40 wt. %. In certain embodiments as otherwise described herein, oxygen is present in an amount within the range of 20 wt. % to 35 wt. %, e.g., 25 wt. % to 35 wt. %, or 20 wt. % to 30 wt. %. Oxygen is calculated as elemental oxygen on a calcined basis.

As described above, the catalyst composition includes one or more promoters selected from vanadium, magnesium, copper, cobalt, iron, cerium, manganese, calcium, nickel, boron, zirconium, potassium, and silicon, in a total amount within the range of 0.1 wt. % to 25 wt. % (i.e., calculated on an elemental basis as-calcined). In certain embodiments of the compositions as otherwise described herein, the composition includes only one promoter selected from vanadium, magnesium, copper, cobalt, iron, cerium, manganese, calcium, nickel, boron, zirconium, potassium, and silicon. The person of ordinary skill in the art will, based on the description herein, select one or more appropriate promoters. For example, in certain embodiments of the compositions as otherwise described herein, the composition includes one or more (e.g., one) promoters selected from vanadium, magnesium, copper, cobalt, and iron. In another example, in certain embodiments of the compositions as otherwise described herein, the composition includes one or more (e.g., one) promoter selected from vanadium, magnesium, copper, and cobalt. In yet another example, in certain embodiments of the composition as otherwise described herein, the composition includes one or more (e.g., one) promoters selected from vanadium, cobalt, and iron. In certain embodiments of the compositions as otherwise described herein, the composition includes a first promoter selected from vanadium, magnesium, copper, cobalt, and iron (e.g., selected from vanadium, magnesium, copper, and cobalt; or selected from vanadium, cobalt, and iron) and a second promoter selected from vanadium, magnesium, copper, cobalt, and iron. For example, in certain such embodiments, the composition includes a first promoter selected from vanadium and magnesium, and copper as a second promoter.

As described above, the total amount of the promoters in the composition is in the range of 0.1 wt. % to 25 wt. %. For example, in certain embodiments of the compositions as otherwise described herein, the one or more promoters are present in a total amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, the one or more promoters are present in a total amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, the one or more promoters are present in a total amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, the one or more promoters are present in a total amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, the one or more promoters are present in a total amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, the one or more promoters are present in a total amount within the range of 0.1 wt. % to 5 wt. %, e.g., 0.5 wt. % to 5 wt. %, or 1 wt. % to 5 wt. %, or 2 wt. % to 5 wt. %. All amounts of promoters described herein are calculated on an elemental, as-calcined basis. When multiple promoters are present, their total amount can be selected so as to fall within the ranges described above.

In certain embodiments of the compositions as otherwise described herein, copper is present in the composition, for example, in an amount within the range of 0.1 wt. % to 25 wt. %. For example, in certain embodiments of the compositions as otherwise described herein, copper is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, copper is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, copper is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, copper is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, copper is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, copper is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, copper is not present in the composition.

In certain copper-containing embodiments as described herein, another promoter, e.g., selected from vanadium and magnesium, is further present in the composition in an amount within the range of 0.1 wt. % to 20 wt. %, e.g., within the range of 0.5 wt. % to 17.5 wt. %, or 1 wt. % to 15 wt. %, or in any other range as described below.

In certain embodiments of the compositions as otherwise described herein, vanadium is present in the composition, for example, in an amount within the range of 0.1 wt. % to 25 wt. %. For example, in certain embodiments of the compositions as otherwise described herein, vanadium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, vanadium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, vanadium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, vanadium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, vanadium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, vanadium is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, vanadium is not present in the composition.

In certain embodiments of the compositions as otherwise described herein, magnesium is present in the composition, for example, in an amount within the range of 0.1 wt. % to 25 wt. %. For example, in certain embodiments of the compositions as otherwise described herein, magnesium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, magnesium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, magnesium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, magnesium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, magnesium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, magnesium is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, magnesium is not present in the composition.

In certain embodiments of the compositions as otherwise described herein, cobalt is present in the composition, for example, in an amount within the range of 0.1 wt. % to 25 wt. %. For example, in certain embodiments of the compositions as otherwise described herein, cobalt is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, cobalt is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, cobalt is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, cobalt is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, cobalt is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, cobalt is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, cobalt is not present in the composition.

In certain embodiments of the compositions as otherwise described herein, iron is present in the composition, for example, in an amount within the range of 0.1 wt. % to 25 wt. %. For example, in certain embodiments of the compositions as otherwise described herein, iron is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, iron is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, iron is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, iron is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, iron is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, iron is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, iron is not present in the composition.

In certain embodiments of the compositions as otherwise described herein, cerium is present in the composition, for example, in an amount within the range of 0.1 wt. % to 25 wt. %. For example, in certain embodiments of the compositions as otherwise described herein, cerium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, cerium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, cerium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, cerium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, cerium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, cerium is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, cerium is not present in the composition.

In certain embodiments of the compositions as otherwise described herein, manganese is present in the composition, for example, in an amount within the range of 0.1 wt. % to 25 wt. %. For example, in certain embodiments, manganese is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, manganese is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, manganese is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, manganese is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, manganese is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, manganese is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, manganese is not present in the composition.

In certain embodiments of the compositions as otherwise described herein, calcium is present in the composition, for example, in an amount within the range of 0.1 wt. % to 25 wt. %. For example, in certain embodiments of the compositions as otherwise described herein, calcium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, calcium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, calcium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, calcium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, calcium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, calcium is present in an amount within the range of 0.1 wt. % to 5 wt. %, e.g., 0.5 wt. % to 5 wt. %, or 1 wt. % to 5 wt. %, or 2 wt. % to 5 wt. %. Calcium can be present in the composition as a component of the crystalline spinel, and/or as part of a separate calcium containing phase as described below. However, in other embodiments, calcium is not present in the composition.

In certain embodiments of the compositions as otherwise described herein, silicon is present in the composition, for example, in an amount within the range of 0.1 wt. % to 20 wt. %. For example, in certain embodiments of the compositions as otherwise described herein, silicon is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, silicon is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, silicon is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, silicon is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, silicon is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, silicon is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, silicon is not present in the composition.

In certain embodiments of the compositions as otherwise described herein, nickel is present in the composition, for example, in an amount within the range of 0.1 wt. % to 20 wt. %. For example, in certain embodiments of the compositions as otherwise described herein, nickel is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, nickel is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, nickel is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, nickel is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, nickel is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, nickel is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, nickel is not present in the composition.

In certain embodiments of the compositions as otherwise described herein, boron is present in the composition, for example, in an amount within the range of 0.1 wt. % to 20 wt. %. For example, in certain embodiments of the compositions as otherwise described herein, boron is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, boron is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, boron is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, boron is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, boron is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, boron is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, boron is not present in the composition.

In certain embodiments of the compositions as otherwise described herein, zirconium is present in the composition, for example, in an amount within the range of 0.1 wt. % to 20 wt. %. For example, in certain embodiments of the compositions as otherwise described herein, zirconium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, zirconium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, zirconium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, zirconium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, zirconium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, zirconium is present in an amount within the range of 0.1 wt. % to 5 wt. %, e.g., 0.5 wt. % to 5 wt. %, or 1 wt. % to 5 wt. %, or 2 wt. % to 5 wt. %. However, in other embodiments, zirconium is not present in the composition.

In certain embodiments of the compositions as otherwise described herein, potassium is present in the composition, for example, in an amount within the range of 0.1 wt. % to 20 wt. %. For example, in certain embodiments of the compositions as otherwise described herein, potassium is present in an amount within the range of 0.5 wt. % to 25 wt. %, or 1 wt. % to 25 wt. %, or 5 wt. % to 25 wt. %, or 10 wt. % to 25 wt. %. In certain embodiments of the compositions as otherwise described herein, potassium is present in an amount within the range of 0.1 wt. % to 20 wt. %, e.g., 0.5 wt. % to 20 wt. %, or 1 wt. % to 20 wt. %, or 2 wt. % to 20 wt. %, or 3 wt. % to 20 wt. %, or 5 wt. % to 20 wt. %, or 7 wt. % to 20 wt. %, or 10 wt. % to 20 wt. %, or 15 wt. % to 20 wt. %. In certain embodiments of the compositions as otherwise described herein, potassium is present in an amount within the range of 0.1 wt. % to 15 wt. %, e.g., 0.5 wt. % to 15 wt. %, or 1 wt. % to 15 wt. %, or 2 wt. % to 15 wt. %, or 3 wt. % to 15 wt. %, or 5 wt. % to 15 wt. %, or 7 wt. % to 15 wt. %. In certain embodiments of the compositions as otherwise described herein, potassium is present in an amount within the range of 0.1 wt. % to 10 wt. %, e.g., 0.5 wt. % to 10 wt. %, or 1 wt. % to 10 wt. %, or 2 wt. % to 10 wt. %, or 3 wt. % to 10 wt. %, or 5 wt. % to 10 wt. %. In certain embodiments of the compositions as otherwise described herein, potassium is present in an amount within the range of 0.1 wt. % to 7 wt. %, e.g., 0.5 wt. % to 7 wt. %, or 1 wt. % to 7 wt. %, or 2 wt. % to 7 wt. %, or 3 wt. % to 7 wt. %. In certain embodiments of the compositions as otherwise described herein, potassium is present in an amount within the range of 0.1 wt. % to 5 wt. %, e.g., 0.5 wt. % to 5 wt. %, or 1 wt. % to 5 wt. %, or 2 wt. % to 5 wt. %. Potassium can be present as a component of the crystalline spinel, and/or as a separate potassium-containing phase as described below. However, in other embodiments, potassium is not present in the As zinc aluminate spinel itself typically has an idealized chemical formula of ZnAl₂O₄, it can be desirable to select a ratio of zinc to aluminum that, together with other elemental components, provides a desired amount of a spinel structure. In some embodiments of the compositions as otherwise described herein, the composition includes zinc and alumina in an atomic molar ratio (i.e., Zn:Al) within the range of 0.5:2 to 4:2. For example, in certain embodiments of the compositions as otherwise described herein, the composition includes zinc and alumina in an atomic molar ratio within the range of 0.75:2 to 4:2, or 1:2 to 4:2, or 1.25:2 to 4:2, or 1.5:2 to 4:2, or 1.75:2 to 4:2, or 2:2 to 4:2, or 2.25:2 to 4:2, or 2.5:2 to 4:2, or 2.75:2 to 4:2, or 3:2 to 4:2, or 0.5:2 to 3.75:2, or 0.5:2 to 3.5:2, or 0.5:2 to 3.25:2, or 0.5:2 to 3:2, or 0.5:2 to 2.75:2, or 0.5:2 to 2.5:2, or 0.5:2 to 2.25:2, or 0.5:2 to 2:2, or 0.5:2 to 1.75:1, or 0.5:2 to 1.5:2, or 0.75:2 to 1.75:2, or 1:2 to 2:2, or 1.25:2 to 2.25:2, or 1.5:2 to 2.5:2, or 1.75:2 to 2.75:2, or 2:2 to 3:2, or 2.25:2 to 3.25:2, or 2.5:2 to 3.5:2, or 2.75:2 to 3.75:2, or 3:2 to 4:2. In certain such embodiments, the composition has a zinc/alumina atomic ratio of at least 0.75:2, or at least 0.9:2. In certain such embodiments, the composition has a zinc/alumina ratio of no more than 2:2.

In some embodiments of the compositions as otherwise described herein, the composition includes zinc and one or more promoters (e.g., vanadium, magnesium, copper, cobalt, iron, cerium, manganese, calcium, nickel, boron, zirconium, potassium, and/or silicon) in a total atomic molar ratio to zinc (i.e., promoters:Zn) within the range of 0.001:1 to 0.5:1. For example, in certain embodiments of the compositions as otherwise described herein, the composition includes zinc and one or more promoters in a total atomic molar ratio to zinc within the range of 0.005:1 to 0.5:1, or 0.01:1 to 0.5:1, or 0.025:1 to 0.5:1, or 0.05:1 to 0.5:1, or 0.075:1 to 0.5:1, or 0.1:1 to 0.5:1, or 0.125:1 to 0.5:1, or 0.15:1 to 0.5:1, or 0.175:1 to 0.5:1, or 0.2:1 to 0.5:1, or 0.25:1 to 0.5:1, or 0.3:1 to 0.5:1, or 0.35:1 to 0.5:1, or 0.4:1 to 0.5:1, or 0.001:1 to 0.45:1, or 0.001:1 to 0.4:1, or 0.001:1 to 0.35:1, or 0.001:1 to 0.3:1, or 0.001:1 to 0.25:1, or 0.001:1 to 0.2:1, or 0.001:1 to 0.175:1, or 0.001:1 to 0.15:1, or 0.001:1 to 0.125, or 0.001:1 to 0.1, or 0.001:1 to 0.075, or 0.001:1 to 0.05:1, or 0.005:1 to 0.4:1, or 0.01:1 to 0.3.5:1, or 0.02:1 to 0.3:1, or 0.05:1 to 0.2:1.

In various embodiments of the compositions as otherwise described herein, the composition can further include one or more alkali metals and/or alkaline earth metals that is not part of a crystalline spinel. For example, in certain such embodiments, the composition includes one or more of potassium, sodium, magnesium, calcium, rubidium, and cesium, not part of a crystalline spinel. The alkali metal and/or alkaline earth metal can be provided (e.g., via impregnation) as any compound that otherwise provides the metal (e.g., as an oxide) to the calcined catalyst composition (e.g., before a calcination step). For example, in certain embodiments, the alkali metal and/or alkaline earth metal is provided as a salt selected from a carbonate, nitrate, acetate, formate, oxalate, molybdate and citrate, In certain embodiments as otherwise described herein, potassium is provided as a salt, e.g., as a potassium carbonate, introduced via impregnation before a calcination step. The calcination can be the same calcination step used to form the spinel, or a subsequent additional calcination step. Typically, such alkali and alkaline earth metals can be present in the calcined composition in the form of oxides, separate from a crystalline spinel structure. Accordingly, in certain embodiments, the only phase substantially present (e.g., in an amount in excess of 2%, 1% or 0.5%) other than the crystalline spinel and a zinc oxide phase is a phase containing one or more alkali and/or alkaline earth metals, e.g., in the form of an oxide.

In certain embodiments of the compositions as otherwise described herein, the composition includes potassium (e.g., in oxide form) other than any potassium in the crystalline spinel, in an amount within the range of 0.01 wt. % to 5 wt. %. For example, in certain embodiments of the compositions as otherwise described herein, the compositions includes a potassium source in an amount within the range of 0.01 wt. % to 3 wt. %, or 0.01 wt. % to 2 wt. %, or 0.1 wt. % to 5 wt. %, or 0.1 wt. % to 3 wt. %, or 0.1 wt. % to 2 wt. %, or 0.5 wt. % to 5 wt. %, or 0.5 wt. % to 3 wt. %, or 0.5 wt. % to 2 wt. %, or 1 wt. % to 5 wt. %, or 1 wt. % to 3 wt. %, calculated as elemental potassium on a calcined basis.

The person of ordinary skill in the art will appreciate that, unless otherwise indicated, the amounts of material in the calcined catalyst composition are to be calculated on an as-calcined basis, exclusive of any organic material and any adsorbed water.

In certain embodiments, a composition as otherwise described herein includes 0.25 wt. % to 3 wt. % of potassium (e.g., as oxide); 30 wt. % to 60 wt. % zinc, 10 wt. % to 35 wt. % aluminum, and 1 wt. % to 15 wt. % of a first promoter (e.g., selected from vanadium, magnesium, copper, cobalt, and iron). In certain embodiments, a composition as otherwise described herein includes 0.25 wt. % to 3 wt. % of potassium (e.g., as oxide), 30 wt. % to 60 wt. % zinc, 10 wt. % to 35 wt. % aluminum, and 5 wt. % to 15 wt. % of a first promoter (e.g., selected from vanadium, magnesium, copper, and cobalt; or selected from vanadium, cobalt, and iron). In certain such embodiments, the composition further comprises 1 wt. % to 15 wt. % of a second promoter (e.g., selected from vanadium, magnesium, copper, cobalt, and iron), calculated on an elemental, calcined basis. For example, in certain embodiments as otherwise described herein, the first promoter is selected from vanadium and magnesium and the second promoter is copper.

The person of ordinary skill in the art will appreciate that other components may be present in the compositions as described herein. However, in certain desirable embodiments of the compositions as otherwise described herein, the composition does not include more than 1 wt. % chromium, preferably not including more than 0.5 wt. %, more than 0.1 wt. %, more than 0.05 wt. %, or more less than 0.01 wt. % of chromium. Similarly, in certain embodiments of the compositions as otherwise described herein, the composition does not include more than 1 wt. % iron, e.g., not including more than 0.5 wt. %, more than 0.1 wt. %, more than 0.05 wt. %, or more less than 0.01 wt. % of iron. In certain embodiments of the compositions as otherwise described herein, the composition comprises does not include more than 1 wt. % (e.g., not including more than 0.5 wt. %, more than 0.1 wt. %, more than 0.05 wt. %, or more less than 0.01 wt. %) of each of the lanthanides that is not cerium. In certain embodiments of the compositions as otherwise described herein, the composition does not include more than 1 wt. % (e.g., not including more than 0.5 wt. %, more than 0.1 wt. %, more than 0.05 wt. %, or even more than 0.01 wt. %) of each of the transition metals other than vanadium, manganese, copper, cobalt, and iron. In certain embodiments of the compositions as otherwise described herein, the composition does not include more than 1 wt. % (e.g., more than 0.5 wt. %, more than 0.1 wt. %, more than 0.05 wt. %, or even more than 0.01 wt. %) of elements other than zinc, aluminum, oxygen, carbon, halogen, potassium and the one or more promoters.

In certain desirable embodiments of the compositions as otherwise described herein, the total amount of the one or more promoters (e.g., vanadium, magnesium, copper, cobalt, iron, cerium, manganese, calcium, nickel, boron, zirconium, potassium, and silicon), aluminum, zinc, oxygen, and alkali metal and/or alkaline earth metal is at least 80 wt. %, or at least 85 wt. %, or at least 90 wt. %, or at least 95 wt. %, or at least 97.5 wt. %, or at least 99 wt. % of the composition.

In certain such embodiments of the compositions as otherwise described herein, at least a portion of potassium included in the composition is localized on the surface of a crystalline spinel material comprising one or more promoters, aluminum, and/or zinc occupying tetrahedral and/or octahedral sites of a face-centered cubic array of oxygen. Such materials can be made, for example, by first making a crystalline spinel material (e.g., by calcining a spinel precursor as described herein), then impregnating the material with a potassium source. The person of ordinary skill in the art will appreciate that a substance “localized on a surface” includes the substance chemically bound to an atom of a surface and the substance that is itself part of the surface (e.g., by exchange with surface atoms, intercalation, etc.). A substance “localized on a surface” has a substantially higher concentration (e.g., at least 100% higher) at the surface of the material (including a surface of an internal pore) than in the interior of the material. The person of ordinary skill in the art will further appreciate that the “surface” of a composition does not consist solely of the outermost layer of atoms of a composition, but rather includes, e.g., the outermost 50 nm, 100 nm, 250 nm, 500 nm, 750 nm or even 1 μm of a composition.

The catalyst composition desirably includes a crystalline spinel material in the form of small crystallites. In certain such embodiments of the compositions as otherwise described herein, at least 90 wt. % of the crystalline spinel material is present in the composition as crystallites having a major dimension of less than 500 nm. For example, in certain embodiments of the compositions as otherwise described herein, at least 95 wt. %, or at least 97.5 wt. %, or at least 99 wt. % of the crystalline spinel material is present in the composition as crystallites having a major dimension of less than 500 nm, or less than 400 nm, or less than 300 nm, or less than 200 nm, or less than 100 nm, or less than 75 nm, or less than 50 nm, or less than 25 nm. Crystallites can be present as agglomerates of individual crystals; such agglomerates can have a larger particle size.

In certain embodiments as otherwise described herein, the catalyst composition (e.g., including a crystalline spinel material in the form of small crystallites) has a surface area of at least 20 m²/g. For example, in certain such embodiments, the surface area of the catalyst composition is within the range of 20 m²/g to 300 m²/g, or 20 m²/g to 250 m²/g, or 20 m²/g to 200 m²/g, or 20 m²/g to 150 m²/g, or 20 m²/g to 100 m²/g, or 20 m²/g to 75 m²/g, or 50 m²/g to 300 m²/g, or 75 m²/g to 300 m²/g, or 100 m²/g to 300 m²/g, or 150 m²/g to 300 m²/g, or 200 m²/g to 300 m²/g, or 250 m²/g to 300 m²/g, or 25 m²/g to 125 m²/g, or 75 m²/g to 175 m²/g, or 125 m²/g to 225 m²/g.

As the person of ordinary skill in the art will appreciate, and as described in more detail below, the compositions of the present disclosure can be prepared in a variety of manners. In certain desirable embodiments, a composition as otherwise described herein is in the form of a calcined precipitate. For example, in some embodiments of the compositions of the disclosure, the catalyst composition comprises a crystalline spinel material that is the calcined product of the precipitated product of a solution of zinc ions, aluminum ions, ions of one or more promoters (e.g., vanadium, magnesium, manganese, cerium, copper, cobalt, calcium, nickel, boron, zirconium, potassium, and/or silicon), and hydroxide ions (e.g., a layered double hydroxide or oxy-hydride material). In certain such embodiments of the compositions as otherwise described herein, the catalyst composition comprises the calcined product of a crystalline spinel material impregnated with a potassium source.

Another aspect of the disclosure is a method of preparing a water-gas shift reaction catalyst composition. The method includes providing a spinel precursor comprising zinc, aluminum, oxygen, and one or more promoters selected from vanadium, magnesium, copper, cobalt, iron, cerium, manganese, calcium, nickel, boron, zirconium, potassium, and silicon, then calcining the spinel precursor. The catalyst composition comprises zinc, present in the material in an amount within the range of 20 wt. % to 70 wt. %; aluminum, present in the material in an amount within the range of 5 wt. % to 40 wt. %; one or more promoters selected from vanadium, magnesium, copper, cobalt, iron, cerium, manganese, calcium, nickel, boron, zirconium, potassium, and silicon, each promoter present in the composition in an amount within the range of 0.1 wt. % to 20 wt. %; and oxygen, present in the material in an amount within the range of 15 wt. % to 50 wt. %, calculated on an elemental, calcined basis. The amounts and identities of the various components can be as otherwise described above with respect to the catalyst compositions of the disclosure. The person of ordinary skill in the art can provide a spinel group precursor suitable to provide the desired amounts of zinc, aluminum, oxygen, and the one or more promoters.

As described above, in certain desirable embodiments, a spinel precursor is calcined to provide the compositions of the disclosure. The spinel precursor may be any material that forms a crystalline spinel material, i.e., a material having a structure in which one or more promoters, aluminum, and/or zinc occupy tetrahedral and/or octahedral sites of a face-centered cubic array of oxygen, upon calcination. For example, in certain embodiments of the methods as otherwise described herein, the spinel precursor comprises a layered double hydroxide, oxy-hydride, hydroxide, or amorphous material. The spinel precursor may, in other embodiments of the methods as otherwise described herein, be any of a number of spinel precursors known in the art (e.g., hydrogels). In certain embodiments of the methods as otherwise described herein, the spinel precursor is the precipitated product of a solution of ions. For example, in certain embodiments of the methods as otherwise described herein, the spinel precursor is the precipitated product of a solution of zinc ions, aluminum ions, ions of one or more promoters (e.g., vanadium, magnesium, copper, cobalt, iron, cerium, manganese, calcium, nickel, boron, zirconium, potassium, and/or silicon) and hydroxide ions.

In certain such embodiments of the methods as otherwise described herein, such a precipitated product comprises a layered double hydroxide or oxy-hydroxide structure, i.e., is a layered double hydroxide or oxy-hydroxide material.

As described above, the method includes calcining the spinel precursor. In some embodiments of the methods as otherwise described herein, the calcination step is performed at a temperature within the range of 200° C. to 700° C. For example, in certain embodiments of the methods as otherwise described herein, the calcination step is performed at a temperature within the range of 200° C. to 675° C., or 200° C. to 650° C., or 200° C. to 625° C., or 200° C. to 600° C., or 200° C. to 575° C., or 200° C. to 550° C., or 225° C. to 700° C., or 250° C. to 700° C., or 275° C. to 700° C., or 300° C. to 700° C., or 325° C. to 700° C., or 350° C. to 700° C., or 225° C. to 675° C., or 250° C. to 650° C., or 275° C. to 625° C., or 300° C. to 600° C., or 325° C. to 575° C., or 350° C. to 550° C., or 400° C. to 500° C.

In some embodiments of the methods as otherwise described herein, the spinel precursor is calcined for a period of time within the range of 5 min. to 12 hr. For example, in certain embodiments of the methods as otherwise described herein, the spinel precursor is calcined for a period of time within the range of 10 min. to 12 hr., or 15 min. to 12 hr., or 20 min. to 12 hr., or 30 min. to 12 hr., or 45 min. to 12 hr., or 1 hr. to 12 hr., or 1.5 hr. to 12 hr., or 2 hr. to 12 hr., or 5 min. to 11 hr., or 5 min. to 10 hr., or 5 min. to 9 hr., or 5 min. to 8 hr., or 5 min. to 7.5 hr., or 5 min. to 7 hr., or 5 min. to 6.5 hr., or 5 min. to 6 hr., or 5 min. to 5.5 hr., or 5 min. to 5 hr., or 30 min. to 11 hr., or 1 hr. to 10 hr., or 1.5 hr. to 9 hr., or 2 hr. to 8 hr.

In some embodiments of the methods as otherwise described herein, the spinel precursor is dried before calcination. In some embodiments of the methods as otherwise described herein, the spinel precursor is dried at a temperature within the range of 40° C. to 200° C. For example, in certain embodiments of the methods as otherwise described herein, the spinel precursor is dried at a temperature within the range of 60° C. to 200° C., or 80° C. to 200° C., or 100° C. to 200° C., or 40° C. to 180° C., or 40° C. to 160° C., or 40° C. to 140° C., or 60° C. to 180° C., or 80° C. to 160° C., or 100° C. to 140° C.

In some embodiments of the methods as otherwise described herein, the spinel precursor is dried for a period of time within the range of 15 min. to 36 hr. For example, in certain embodiments of the methods as otherwise described herein, the spinel precursor is dried for a period of time within the range of 15 min. to 30 hr., or 15 min. to 24 hr., or 15 min. to 22 hr., or 15 min. to 20 hr., or 1 hr. to 36 hr., or 2 hr. to 36 hr., or 4 hr. to 36 hr., or 8 hr. to 36 hr., or 1 hr. to 30 hr., or 1 hr. to 24 hr., or 1 hr. to 22 hr., or 1 hr. to 20 hr.

In some embodiments of the methods as otherwise described herein, the method of preparing a water-gas shift reaction catalyst composition further comprises providing an alkali metal and/or alkaline earth metal source to the composition. In certain such embodiments of the methods as otherwise described herein, the method comprises impregnating the calcined composition with an alkali metal and/or alkaline earth metal source, and calcining the impregnated composition. The calcining can be the same calcination that calcines the spinel, or a separate calcination. The person of ordinary skill in the art will use conventional methodologies to perform such impregnations, based on the disclosure herein.

As noted above with respect to the various aspects and embodiments of the catalyst compositions of the disclosure, the alkali metal and/or alkaline earth metal source (e.g., a potassium source) may be, for example, a carbonate, nitrate, acetate, formate, oxalate, molybdate, or citrate, or any compound that provides an alkali metal and/or alkaline earth metal to the calcined catalyst composition. For example, in certain embodiments of the methods as otherwise described herein, the method comprises impregnating the calcined composition with an aqueous solution of K₂CO₃, and calcining the impregnated composition.

In certain such embodiments of the methods as otherwise described herein, the impregnated composition is calcined at a temperature within the range of 200° C. to 700° C. For example, in certain embodiments of the methods as otherwise described herein, the impregnated composition is calcined at a temperature within the range of 200° C. to 675° C., or 200° C. to 650° C., or 200° C. to 625° C., or 200° C. to 600° C., or 200° C. to 575° C., or 200° C. to 550° C., or 225° C. to 700° C., or 250° C. to 700° C., or 275° C. to 700° C., or 300° C. to 700° C., or 325° C. to 700° C., or 350° C. to 700° C., or 225° C. to 675° C., or 250° C. to 650° C., or 275° C. to 625° C., or 300° C. to 600° C., or 325° C. to 575° C., or 350° C. to 550° C., or 400° C. to 500° C.

In certain such embodiments of the methods as otherwise described herein, the impregnated composition is calcined for a period of time within the range of 5 min. to 12 hr. For example, in certain embodiments of the methods as otherwise described herein, the impregnated composition is calcined for a period of time within the range of 10 min. to 12 hr., or 15 min. to 12 hr., or 20 min. to 12 hr., or 30 min. to 12 hr., or 45 min. to 12 hr., or 1 hr. to 12 hr., or 1.5 hr. to 12 hr., or 2 hr. to 12 hr., or 5 min. to 11 hr., or 5 min. to 10 hr., or 5 min. to 9 hr., or 5 min. to 8 hr., or 5 min. to 7.5 hr., or 5 min. to 7 hr., or 5 min. to 6.5 hr., or 5 min. to 6 hr., or 5 min. to 5.5 hr., or 5 min. to 5 hr., or 30 min. to 11 hr., or 1 hr. to 10 hr., or 1.5 hr. to 9 hr., or 2 hr. to 8 hr.

In certain such embodiments of the methods as otherwise described herein, the impregnated composition is dried before calcination. In certain such embodiments of the methods as otherwise described herein, the impregnated composition is dried at a temperature within the range of 40° C. to 200° C. For example, in certain embodiments of the methods as otherwise described herein, the spinel precursor is dried at a temperature within the range of 60° C. to 200° C., or 80° C. to 200° C., or 100° C. to 200° C., or 40° C. to 180° C., or 40° C. to 160° C., or 40° C. to 140° C., or 60° C. to 180° C., or 80° C. to 160° C., or 100° C. to 140° C.

In some embodiments of the methods as otherwise described herein, the impregnated composition is dried for a period of time within the range of 15 min. to 36 hr. For example, in certain embodiments of the methods as otherwise described herein, the impregnated composition is dried for a period of time within the range of 15 min. to 30 hr., or 15 min. to 24 hr., or 15 min. to 22 hr., or 15 min. to 20 hr., or 1 hr. to 36 hr., or 2 hr. to 36 hr., or 4 hr. to 36 hr., or 8 hr. to 36 hr., or 1 hr. to 30 hr., or 1 hr. to 24 hr., or 1 hr. to 22 hr., or 1 hr. to 20 hr.

Another aspect of the disclosure is a catalyst composition prepared by a method as described herein. Advantageously, the present inventors have determined that use of such catalyst compositions can catalyze a high-temperature water-gas shift reaction at an efficiency comparable to conventional chromium-containing catalyst materials, and in certain embodiments can be operable under a wider range of steam-to-gas ratios relative to conventional catalyst materials.

The methods described herein can provide materials especially for use in catalytic processes. In certain embodiments, the methods described herein provide a catalyst composition that is the calcined product of a spinel precursor comprising zinc, aluminum, oxygen, and one or more promoters selected from vanadium, magnesium, copper, cobalt, iron, cerium, manganese, calcium, nickel, boron, zirconium, potassium, and silicon, with an alkali metal or alkaline earth metal (e.g., potassium, sodium, magnesium, calcium, rubidium, and/or cesium) source optionally provided at the surface thereof via impregnation.

The compositions described herein are especially useful in water-gas shift reactions, e.g., performed at relatively high temperatures. As the person of ordinary skill in the art understands, a water-gas shift reaction converts water and carbon monoxide to hydrogen and carbon dioxide. Accordingly, another aspect of the disclosure is a method for performing a water-gas shift reaction that includes contacting a feed comprising water and carbon monoxide with a catalyst composition as described herein under conditions to cause formation of hydrogen and carbon dioxide. The feed can be formed, for example, by the gasification of an organic feedstock such as coal or biomass.

In some embodiments of the water-gas shift methods as otherwise described herein, the feed includes water and gases (i.e., including carbon monoxide) in a molar steam-to-gas (S/G) ratio of at most 1. For example, in certain such embodiments, the S/G ratio of the feed is at most 0.8, or at most 0.6, or at most 0.5, or at most 0.4, or at most 0.3, or within the range of 0.2 to 1, or 0.4 to 1, or 0.5 to 1, or 0.6 to 1, or 0.7 to 1, or 0.1 to 0.6, or 0.2 to 0.7, or 0.3 to 0.8, or 0.4 to 0.9.

In certain such embodiments of the hydrogen formation methods as otherwise

described herein, the feed includes carbon monoxide in an amount within the range of 5 wt. % to 25 wt. %. For example, in certain embodiments of the hydrogen formation methods as otherwise described herein, the feed includes carbon monoxide in an amount within the range of 5 wt. % to 20 wt. %, or 5 wt. % to 15 wt. %, or 10 wt. % to 25 wt. %, or 15 wt. % to 25 wt. %, or 10 wt. % to 20 wt. %, or 10 wt. % to 15 wt. %. In some embodiments of the hydrogen formation methods as otherwise described herein, the feed includes hydrogen. In some embodiments of the hydrogen formation methods as otherwise described herein, the feed includes carbon dioxide and/or nitrogen.

The contacting of the feed with the catalyst compositions described herein can be conducted in a variety of ways familiar to the person of ordinary skill in the art. Conventional equipment and processes can be used in conjunction with the catalyst compositions of the disclosure to provide beneficial performance. Thus, the catalyst may be contained in one bed within a reactor vessel or divided up amount a plurality of beds within a reactor. The reaction system may contain one or more reaction vessels in series. The feed to the reaction zone can flow vertically upwards, or downwards through the catalyst bed in a typical plug flow reactor, or horizontally across the catalyst bed in a radial flow type reactor.

The catalyst compositions described here are desirably in a substantially reduced form. Accordingly, it can be desirable to treat the catalyst composition with hydrogen, for example, before contacting the catalyst composition with the feed. Such treatment can be performed, for example, at a temperature within the range of 250° C. to 400° C. in flowing hydrogen, for example, having a GHSV within the range of 10,000 h⁻¹ to 30,000 h⁻¹ (e.g., within the range of 12,000 h⁻¹ to 24,000 h⁻¹ at a pressure within the range of 2 bar to 16 bar, for a time of at least 4 hours, for example, a time within the range of 8 hours to 24 hours.

The contacting of the feed with the catalyst composition can be performed using conventional methods. For example, the feed may be introduced into the reaction zone containing the catalyst composition at a constant rate, or alternatively, at a variable rate. The hydrogen formation can be conducted under vapor phase conditions.

In some embodiments of the hydrogen formation methods as otherwise described herein, the feed is contacted with the provided catalyst composition at a gas hourly space velocity within the range of 10,000 h⁻¹ to 30,000 h⁻¹. For example, in certain embodiments of the hydrogen formation methods as otherwise described herein, the feed is contacted with the provided catalyst composition at a gas hourly space velocity of 12,000 h⁻¹ to 30,000 h⁻¹, or 14,000 h⁻¹ to 30,000 h⁻¹, or 16,000 h⁻¹ to 30,000 h⁻¹, or 10,000 h⁻¹ to 28,000 h⁻¹, or 10,000 h⁻¹ to 26,000 h⁻¹, or 10,000 h⁻¹ to 24,000 h⁻¹, or 10,000 to 22,000 h⁻¹, or 10,000 h⁻¹ to 20,000 h⁻¹, or 12,000 h⁻¹ to 28,000 h⁻¹, or 14,000 h⁻¹ to 26,000 h⁻¹, or 16 h⁻¹ to 24,000 h⁻¹, or 16,000 h⁻¹ to 24,000 h⁻¹.

In some embodiments of the hydrogen formation methods as otherwise described herein, the method is carried out at a temperature within the range of 250° C. to 550° C. For example, in certain embodiments of the hydrogen formation methods as otherwise described herein, the method is carried out at a temperature within the range of 275° C. to 550° C., or 300° C. to 550° C., or 325° C. to 550° C., or 250° C. to 525° C., or 250° C. to 500° C., or 250° C. to 475° C., or 250° C. to 450° C., or 250° C. to 425° C., or 250° C. to 400° C., or 250° C. to 375° C., or 275° C. to 500° C., or 300° C. to 475° C., or 325° C. to 450° C., or 325° C. to 425° C., or 325° C. to 400° C.

In some embodiments of the hydrogen formation methods as otherwise described herein, the method is carried out at a pressure within the range of 5 barg to 40 barg. For example, in certain embodiments of the hydrogen formation methods as otherwise described herein, the method is carried out at a pressure within the range of 7.5 barg to 40 barg, or 10 barg to 40 barg, or 12.5 barg to 40 barg, or 15 barg to 40 barg, or 20 barg to 40 barg, or 25 barg to 40 barg, or 5 barg to 35 barg, or 5 barg to 30 barg, or 5 barg to 25 barg, or 5 barg to 20 barg, or 5 barg to 15 barg, or 7.5 barg to 35 barg, or 10 barg to 30 barg, or 12.5 barg to 25 barg.

For example, in certain embodiments as otherwise described herein, the water-gas shift reaction is a high-temperature shift reaction, e.g., performed at a temperature in the range of 300-450° C. In other embodiments as otherwise described herein, the water-gas shift reaction is a medium-temperature shift reaction, e.g., performed at a temperature in the range of 220-295° C. And in other embodiments as otherwise described herein, the water-gas shift reaction is a low-temperature shift reaction, e.g., performed at a temperature in the range of 180-220° C.

### EXAMPLES

The Examples that follow are illustrative of specific embodiments of the invention, and various uses thereof. They are set forth for explanatory purposes only, and are not to be taken as limiting the invention.

### Example 1. Zn/Al Catalyst Preparation

A precursor solution was prepared by mixing 4.654 mL of 4.297M Zn(NO₃)₂ solution, 32.329 mL of 1.361M Al(NO₃)₃ solution, and 0.667 mL of 3M Co(NO₃)₂ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E1.

A precursor solution was prepared by mixing 5.48 mL of 4.197M Zn(NO₃)₂ solution, 15.02 mL of 1.361M Al(NO₃)₃ solution, and 8.936 g of VO(C₂O₄) solution (5.83 wt. % V), and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E2.

A precursor solution was prepared by mixing 5.48 mL of 4.197M Zn(NO₃)₂ solution, 17.53 mL of 1.361M Al(NO₃)₃ solution, and 5.958 g of VO(C₂O₄) solution (5.83 wt. % V), and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E3.

A precursor solution was prepared by mixing 11.401 g of 4.197M Zn(NO₃)₂ solution, 21.143 g of 1.361M Al(NO₃)₃ solution, 3.797 mL of 0.79M VO(C₂O₄) solution, and 1.471 mL of 2.04M Cu(NO₃)₂ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E4.

A precursor solution was prepared by mixing 5.24 mL of 4.197M Zn(NO₃)₂ solution, 16.16 mL of 1.361M Al(NO₃)₃ solution, 13.92 mL of 0.79M VO(C₂O₄) solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E5.

A precursor solution was prepared by mixing 8.35 mL of 4.194M Zn(NO₃)₂ solution, 15.65 mL of 1.361M Al(NO₃)₃ solution, 1.35 mL of 1.5M Fe(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E6.

A precursor solution was prepared by mixing 7.87 mL of 4.194M Zn(NO₃)₂ solution, 12.93 mL of 1.361M Al(NO₃)₃ solution, 2.93 mL of 1.5M Fe(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E7.

A precursor solution was prepared by mixing 5.48 mL of 4.194M Zn(NO₃)₂ solution, 17.53 mL of 1.361M Al(NO₃)₃ solution, 4.54 mL of 1.5M Fe(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E8.

A precursor solution was prepared by mixing 13.51 mL of 4.479M Zn(NO₃)₂ solution, 29.39 mL of 1.361M Al(NO₃)₃ solution, 1 mL of 3M Mg(NO₃)₂ solution, and 1.98 mL of 2.04M Cu(NO₃)₂ solution, and diluting to 100 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide catalyst E9.

A precursor solution was prepared by mixing 14.4 mL of 4.203M Zn(NO₃)₂ solution, 29.39 mL of 1.361M Al(NO₃)₃ solution, and diluting the mixture to 100 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE1.

A precursor solution was prepared by mixing 6.98 mL of 4.297M Zn(NO₃)₂ solution, 22.04 mL of 1.361M Al(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE2.

A precursor solution was prepared by mixing 5.12 mL of 4.297M Zn(NO₃)₂ solution, 32.33 mL of 1.361M Al(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE3.

A precursor solution was prepared by mixing 8.30 mL of 3.975M Zn(NO₃)₂ solution, 19.40 mL of 1.361M Al(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE4.

A precursor solution was prepared by mixing 8.35 mL of 4.194M Zn(NO₃)₂ solution, 15.65 mL of 1.361M Al(NO₃)₃ solution and 0.98 mL 2.078M Ti(OH)₂[(CH₃CH(O—)CO₂NH₄]₂, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE5.

A precursor solution was prepared by mixing 3.95 mL of 4.053M Zn(NO₃)₂ solution, 11.02 mL of 1.361M Al(NO₃)₃ solution, 16.67 mL of 1.5M Fe(NO₃)₃ solution, and diluting to 50 mL with DI water. A base solution was prepared by mixing 100 mL of 10% KOH solution and 400 mL of 25% K₂CO₃ solution. The precursor solution and the base solution were mixed together at 60° C. to cause a precipitate to form. The stirred suspension was heated to 60° C. for 30 min. The precipitate was filtered and washed with deionized water and dried at 105° C. The dried filter cake was calcined at 450° C. for two hours. The resulting powder was impregnated with an aqueous solution of K₂CO₃, dried at 105° C., and calcined at 450° C. for two hours to provide comparative catalyst CE6.

TABLE 1
Catalyst Compositions

| | Zn %* | Al %* | K %* | Promoter | Promoter %* | Zn/Al** |
|---|---|---|---|---|---|---|
| E1 | 32.4 | 29.4 | 1 | Co | 2.9 | 0.5 |
| E2 | 39.1 | 14.4 | 1 | V | 13.5 | 1.1 |
| E3 | 40.6 | 17.4 | 1 | V | 9.4 | 1.0 |
| E4 | 48.1 | 14.6 | 1 | V | 3.8 | 1.4 |
| | | | | Cu | 4.7 | |
| E5 | 36.8 | 15.2 | 1 | V | 14.3 | 1 |
| | | | | Cu | 3.5 | |
| E6 | 55.9 | 14.0 | 1 | Fe | 2.8 | 1.6 |
| E7 | 54.8 | 12.1 | 1 | Fe | 6.2 | 1.9 |
| E8 | 41.4 | 17.7 | 1 | Fe | 10.5 | 1.0 |
| E9 | 53.4 | 14.6 | 1 | Mg | 1 | 1.5 |
| | | | | Cu | 3.5 | |
| CE1 | 56.8 | 15.5 | 1 | | | 1.5 |
| CE2 | 49.4 | 20.4 | 1 | | | 1 |
| CE3 | 35.7 | 29.4 | 1 | | | 0.5 |
| CE4 | 53.5 | 17.7 | 1 | | | 1.3 |
| CE5 | 55.9 | 14.0 | 1 | Ti | 2.5 | 1.6 |
| CE6 | 25.8 | 10.0 | 1 | Fe | 34.4 | 1.1 |

*Calculated on a weight basis.
**Calculated on an atomic molar basis.

### Example 2. Hydrogen Formation

Catalysts prepared according to Example 1 were reduced at 330° C. at 3.4 barg for 16 h with the feed gas and tested in a microreactor test unit under typical high-temperature shift (HTS) conditions. A feed containing 23.2% N₂, 12.8% CO, 7.8% CO₂, and balance hydrogen was passed over the catalyst bed at gas hourly space velocity (GHSV) of 18,000 h⁻¹ with an amount of water to provide a steam-to-gas (S/G) ratio (i.e., the molar ratio of H₂O to the total of H₂, N₂, CO₂, and CO) of 0.6, at a total pressure of 15 barg. The catalyst bed temperature was gradually increased from 330° C. to 371° C. The catalysts were then twice subjected to a cycle in which temperature of the catalyst bed was increased to 520° C. and held for 24 h, and then lowered to 371° C. and held for 24 h. After temperature cycling, the S/G ratio was lowered to 0.3 and the total pressure was increased to 25 barg. The CO concentration at the reactor outlet was monitored with an on-line gas chromatograph (GC). In each run, a commercial high-temperature water-gas shift catalyst was used as an internal standard. The average CO conversion at 371° C. after two temperature cycles (“CO conversion”), and the average methane production at 371° C. and S/G=0.3 (“CH₄ make”) are provided in Table 2. below.

TABLE 2
Catalyst Performance

| | CO Conversion (%) | CH₄ Make (ppm) |
|---|---|---|
| | 371° C. S/G = 0.6 | 371° C. S/G = 0.3 |
| | 15 barg | 15 barg |
| E1 | 50.6 | 5 |
| E2 | 59.9 | 18 |
| E3 | 53.4 | 20 |
| E4 | 87.4 | 15 |
| E5 | 83.2 | 18 |
| E6 | 44.4 | 15 |
| E7 | 42.3 | 16 |
| E8 | 46.4 | 17 |
| E9 | 86.4 | 7 |
| CE1 | 44.4 | 6 |
| CE2 | 35.6 | 7 |
| CE3 | 40.6 | 5 |
| CE4 | 39.4 | 14 |
| CE5 | 30 | 17 |
| CE6 | 27.3 | 5000 |

### Example 3. X-Ray Diffraction

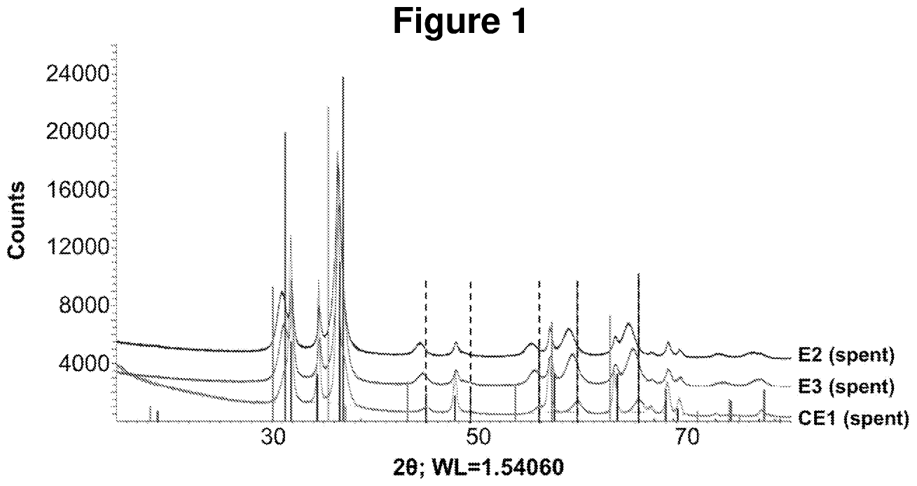

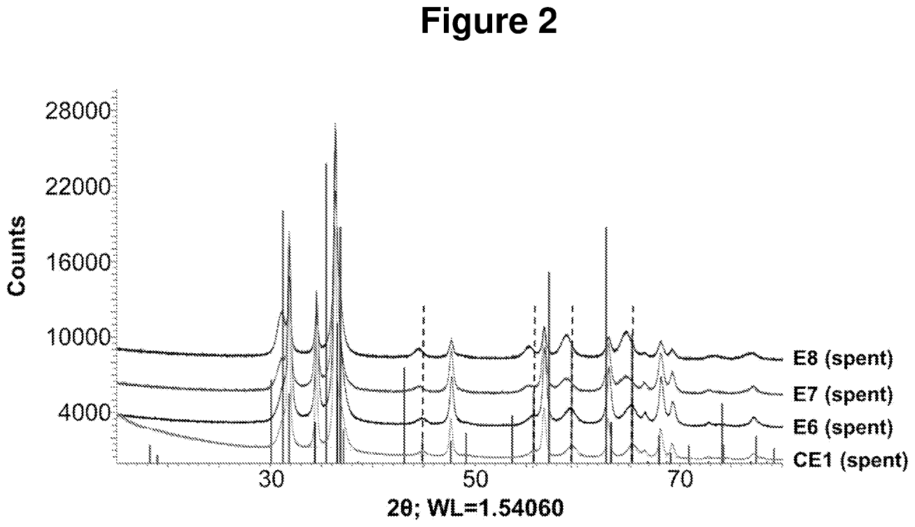

Comparative catalysts CE1, CE2, and CE4, as well as “spent” catalysts (i.e., after hydrogen formation according to Example 2) CE1, CE6, E2, E3, E6, E7, and E8 were characterized using X-ray diffraction (XRD). The catalysts were calcined at 450° C. before characterization. Results indicated that comparative catalysts CE1, CE2, CE4, and spent catalysts CE1, E2, E3, E6, E7, and E8 contained ZnAl₂O₄ spinel and ZnO (see Table 3, below). Comparatively, spent catalyst CE6 contained primarily aluminum-substituted zinc iron oxide (ZnFe_{1.5}Al_{0.5}O₄) and trace amounts of hematite (Fe₃O₄). Representative XRD spectra are shown in FIGS. 1-2.

TABLE 3
XRD Characterization Data

| | | Spinel | | | ZnO | | |
|---|---|---|---|---|---|---|---|
| | Spinel | Size | a | ZnO | Size | | R |
| | % | (nm) | (Å) | % | (nm) | (Å) | wp |
| CE1 | 61* | 65 | 8.0881 | 39 | 83 | A = 3.2497 | 5 |
| | | | | | | C = 5.2061 | |
| CE2 | 73* | 74 | 8.0879 | 27 | 63 | A = 3.2498 | 7 |
| | | | | | | C = 5.2057 | |
| CE4 | 64* | 76 | 8.0909 | 36 | 98 | A = 3.2514 | 5 |
| | | | | | | C = 5.2059 | |
| CE6 | 95** | 22 | 8.314 | 4 | | A = 3.2511 | 2 |
| (spent) | | | | | | C = 5.2080 | |
| CE1 | 59* | 10 | 8.0911 | 41 | 40 | A = 3.2500 | 5.9 |
| (spent) | | | | | | C = 5.2055 | |
| E2 | 85* | 10 | 8.2039 | 15 | 26 | A = 3.2493 | 8 |
| (spent) | | | | | | C = 5.2057 | |
| E3 | 83* | 10 | 8.1619 | 17 | 24 | A = 3.2488 | 7 |
| (spent) | | | | | | C = 5.2050 | |
| E6 | 52* | 9 | 8.1198 | 48 | 30 | A = 3.2499 | 5.4 |
| (spent) | | | | | | C = 5.2061 | |
| E7 | 50* | 9 | 8.1639 | 50 | 31 | A = 3.2507 | 4.3 |
| (spent) | | | | | | C = 5.2068 | |
| E8 | 78* | 11 | 8.1630 | 22 | 32 | A = 3.2511 | 4 |
| (spent) | | | | | | C = 5.2080 | |

*ZnAl₂O₄ spinel;
**ZnFe_{1.5}Al_{0.5}O₄ spinel

As shown in Table 3, the relative amount of the spinel and ZnO phases changes with the Zn/AI ratio (see also Table 1). Because Zn is in excess in each of comparative catalysts CE1, CE2, and CE4, the spinel unit cell dimensions and thus the composition of the spinel does not change. FIG. 1 shows the XRD patterns of un-promoted and vanadium-promoted spent catalysts. All three samples contain broad peaks related to the spinel structure. The unit cell dimensions of the spinel phase in the unpromoted sample (comparative catalyst CE1) closely matches the literature value for ZnAl₂O₄ (a=8.0869 Å). The dimensions of spinel unit cell of the vanadium-promoted samples (catalysts E2, E3) increased significantly with increasing vanadium content (see Table 3). Without being bound by theory, the phenomenon could be explained by the difference in ionic radii of Al³⁺ and V³⁺ in crystals—when a larger cation such as V³⁺ replaces Al³⁺ in the octahedral B lattice of an AB₂O₄ spinel structure, unit cell expansion can occur, shifting corresponding XRD peaks to a lower angle. Notably, the results of Example 2 demonstrated that vanadium-promoted samples provided higher CO conversion at 371° C. and S/G=0.6 than the un-promoted comparative catalysts, and that conversion increased with vanadium content.

A similar phenomenon was also observed for the iron-promoted catalysts. The dimensions of the spinel unit cell of the iron-promoted samples increased with increasing iron content (see Table 3), indicating that iron is incorporated into the ZnAl-spinel phase (see FIG. 2). Analysis of comparative catalyst CE6 after hydrogen formation indicated that the sample contains a cubic spinel phase having a large unit cell (see Table 3), best described by an aluminum-substituted zinc iron oxide (ZnFe_{1.5}Al_{0.5}O₄), as well as trace amounts of hematite. Notably, the results of Example 2 demonstrated that the high-iron sample undesirably provided lower CO conversion and higher methane production at 371° C. and S/G=0.6 than samples containing less iron.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Numerous references have been made to patents and printed publications throughout this specification. Each of the cited references and printed publications are individually incorporated herein by reference in their entirety.

Furthermore, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A water-gas shift reaction catalyst composition comprising:
zinc, present in the composition in an amount within the range of 20 wt. % to 70 wt. %;
aluminum, present in the composition in an amount within the range of 5 wt. % to 40 wt. %;
one or more promoters selected from vanadium, magnesium, copper, cobalt, iron, cerium, manganese, calcium, nickel, boron, zirconium, potassium, and silicon, the one or more promoters being present in the composition in a total amount within the range of 0.1 wt. % to 25 wt. %; and
oxygen, present in the composition in an amount within the range of 15 wt. % to 50 wt. %.

2. The catalyst composition of claim 1, wherein zinc is present in an amount within the range of 25 wt. % to 45 wt. %.

3. The catalyst composition of claim 1, wherein zinc is present in an amount within the range of 45 wt. % to 65 wt. %.

4. The catalyst composition of claim 1, wherein aluminum is present in an amount within the range of 10 wt. % to 35 wt. %.

5. The catalyst composition of claim 1, wherein copper is present in an amount within the range of 0.5 wt. % to 10 wt. %, e.g., 1.5 wt. % to 5 wt. %.

6. The catalyst composition of claim 1, wherein vanadium is present in an amount within the range of 1 wt. % to 15 wt. %, e.g., 2 wt. % to 15 wt. %.

7. The catalyst composition of claim 1, wherein magnesium is present in an amount within the range of 0.1 wt. % to 5 wt. %, e.g., 0.5 wt. % to 3 wt. %.

8. The catalyst composition of claim 1, wherein cobalt is present in an amount within the range of 1 wt. % to 10 wt. %, e.g., 2 wt. % to 5 wt. %.

9. The catalyst composition of claim 1, wherein iron is present in an amount within the range of 1 wt. % to 15 wt. %, e.g., 1.5 wt. % to wt. %.

10. The catalyst composition of claim 1, wherein the atomic molar ratio of zinc to aluminum is within the range of 0.5:2 to 4:2.

11. The catalyst composition of claim 1, wherein the atomic molar ratio of the total of the one or more promoters to zinc is within the range of 0.001:1 to 0.5:1.

12. The catalyst composition of any of claims 1-10, wherein the atomic molar ratio of the total of the one or more promoters to zinc is within the range of to 0.25:1.

13. The catalyst composition of claim 1, wherein the catalyst composition comprises an alkali metal and/or alkaline earth metal that is not part of a crystalline spinel, present in the composition in an amount within the range of 0.01 wt. % to 5 wt. %.

14. The catalyst composition of claim 13, wherein the alkali metal and/or alkaline earth metal is one or more of potassium, sodium, magnesium, calcium, rubidium, and/or cesium, e.g., potassium.

15. The catalyst composition of claim 13, wherein the only phase substantially present (e.g., in an amount in excess of 2%, 1% or other than the crystalline spinel and a zinc oxide phase is a phase containing one or more alkali and/or alkaline earth metals, e.g., in the form of an oxide.

16. The catalyst composition of claim 1, comprising:
wt. % to 3 wt. % of potassium;
wt. % to 60 wt. % zinc;
wt. % to 35 wt. % aluminum; and
1 wt. % to 15 wt. % of a first promoter selected from V, Mg, Cu, Co, and Fe.

17. The catalyst composition of any of claims 1-15, comprising:
wt. % to 3 wt. % of potassium;
wt. % to 60 wt. % zinc;
wt. % to 35 wt. % aluminum; and
wt. % to 15 wt. % of a first promoter selected from V, Mg, Cu, and Co.

18. The catalyst composition of any of claims 1-15, comprising:
wt. % to 3 wt. % of potassium;
wt. % to 60 wt. % zinc;
wt. % to 35 wt. % aluminum; and
wt. % to 15 wt. % of a first promoter selected from V, Co, and Fe.

19. The catalyst composition of claim 16, further comprising 1 wt. % to 15 wt. % of a second promoter selected from V, Mg, Cu, Co, and Fe.

20. The catalyst composition of claim 19, wherein
the first promoter is selected from V and Mg; and
the second promoter is Cu.

21. The catalyst composition of claim 1, wherein the composition does not include more than 1% chromium, preferably not including more than 0.5 wt. %, more than 0.1 wt. %, more than 0.05 wt. %, or even more than 0.01 wt. % of chromium.

22. The catalyst composition of any of claims 1-21, wherein the composition does not include more than 1% iron, preferably not including more than 0.5 wt. %, more than 0.1 wt. %, more than 0.05 wt. %, or even more than 0.01 wt. % of iron.

23. The catalyst composition of claim 1, wherein the composition does not include more than 1% of each the transition metals other than vanadium, manganese, copper, cobalt, and iron, preferably not including more than 0.5 wt. %, more than 0.1 wt. %, more than 0.05 wt. %, or even more than 0.01 wt. % thereof.

24. The catalyst composition of any of claims 1-23, wherein the composition does not include more than 1% cerium, preferably not including more than 0.5 wt. %, more than 0.1 wt. %, more than 0.05 wt. %, or even more than 0.01 wt. % of cerium.

25. The catalyst composition of claim 1, wherein the total amount of the one or more promoters, aluminum, zinc, copper, and the alkali metal and/or alkaline earth metal is at least 80 wt. % (e.g., at least 85 wt. %, at least 90 wt. %, at least 95 wt. %, at least 97.5 wt. %, or at least 99 wt. %) of the catalyst composition.

26. The catalyst composition of claim 1, wherein at least 80 wt. % (e.g., at least 85 wt. %, at least 90 wt. %, at least 95 wt. %, at least 97.5 wt. %, or at least 99 wt. %) of the catalyst composition is made up of
a crystalline spinel material having a structure in which one or more promoters, aluminum, and/or zinc occupy tetrahedral and/or octahedral sites of a face-centered cubic array of oxygen; and
zinc oxide.

27. The catalyst composition of claim 26, wherein at least 50 wt. % (e.g., at least 60 wt. %, or at least 70 wt. %) of the catalyst composition is the crystalline spinel material.

28. The catalyst composition of claim 28, wherein the catalyst composition do not include a promoter-containing phase (e.g., selected from vanadium, magnesium, copper, cobalt, iron, cerium, manganese, calcium, nickel, boron, zirconium, potassium, and silicon, as described below) in an amount in excess of 5% (e.g., in excess of 2% or in excess of 0.1%) of the material.

29. The catalyst composition of any of claims 26-28, wherein the crystalline spinel unit cell includes a dimension of at least 8.1 Å (e.g., at least 8.15 Å, or at least 8.2 Å).

30. The catalyst composition of any of claims 26-29, wherein at least 90 wt. % of the crystalline spinel material and zinc oxide comprises particles having a major dimension of less than 500 nm (e.g., less than 100 nm).

31. The catalyst composition of any of claims 1-30, in the form of a calcined precipitate.

32. A method for preparing a water-gas shift reaction catalyst composition (e.g., according to claim 1), the method comprising
providing a spinel precursor comprising zinc; aluminum; one or more promoters selected from vanadium, magnesium, copper, cobalt, iron, cerium, manganese, calcium, nickel, boron, zirconium, potassium, and silicon; and oxygen; and
calcining the spinel precursor,
wherein the catalyst composition comprises
zinc, present in the composition in an amount within the range of 20 wt. % to 70 wt. %;
aluminum, present in the composition in an amount within the range of 5 wt. % to 40 wt. %;
one or more promoters selected from vanadium, magnesium, copper, cobalt, iron, cerium, manganese, calcium, nickel, boron, zirconium, potassium, and silicon, each promoter present in the composition in an amount within the range of 0.1 wt. % to 20 wt. %; and
oxygen, present in the composition in an amount within the range of 15 wt. % to 50 wt. %.

33. The method according to claim 32, wherein the spinel precursor comprises a layered double hydroxide or oxy-hydroxide material.

34. The method according to claim 32, wherein the spinel precursor is the precipitated product of a solution of zinc ions, aluminum ions, ions of one or more promoters, and hydroxide ions.

35. The method according to any of claims 32-34, wherein the calcination temperature is within the range of 200° C. to 700° C.

36. The method according to any of claims 32-34, wherein the calcination temperature is within the range of 350° C. to 550° C.

37. The method according to any of claims 32-34, further comprising providing an alkali metal and/or alkaline earth metal source to the composition by an impregnation step, wherein a calcination is performed after the impregnation step.

38. The method according to claim 37, wherein the alkali metal source is a potassium source (e.g., K2CO3).

39. A catalyst composition made by a method of any one of claim 32-38.

40. A method for performing a water-gas shift reaction, the method comprising contacting a feed comprising water and carbon monoxide with the catalyst composition of any of claims 1-31 or 39 to form hydrogen and carbon dioxide.

41. A method according to claim 40, wherein the steam-to-gas ratio of the feed is at most 1.

42. A method according to claim 40 or 41, wherein the feed is contacted with the catalyst composition at a temperature within the range of 250° C. to 550° C.

43. A method according to any of claims 40-42, wherein the feed is contacted with the catalyst composition at a pressure within the range of 5 barg to 40 barg.
